(19) United States
(12) Patent Application Publication
(10) Pub. No.: US 2023/0075043 A1
(43) Pub. Date: Mar. 9, 2023

(54) RESOURCE ALLOCATION AND BOOKING SYSTEM

(71) Applicant: Stage Window Limited, Dunbar (GB)

(72) Inventors: Samuel Peachey, Dunbar (GB); Peter Crowther, Edinburgh (GB); James Read, Edinburgh (GB)

(73) Assignee: Stage Window Limited, Dunbar (GB)

(21) Appl. No.: 17/902,584

(22) Filed: Sep. 2, 2022

Related U.S. Application Data
(60) Provisional application No. 63/241,040, filed on Sep. 6, 2021.

(51) Int. Cl. G06Q 10/10; G06Q 10/06

(52) U.S. Cl. CPC G06Q 10/1095; G06Q 10/06314

(57) ABSTRACT

A booking system and corresponding method for allocating a resource or for scheduling an appointment are presented. The booking system includes an interface for receiving booking requests and user information, a memory storing an index data structure and a processor for executing a matching engine. The index data structure has a plurality of parameters specific to an organization associated with the request. The matching engine is configured to compare the booking request with the index data structure to optimize at least one of a resource allocation and a scheduling of appointments.

The present disclosure relates to a resource allocation and booking system and in particular but not exclusively to a computer-implemented system for making and managing bookings and appointments.

### BACKGROUND

Various electronic tools exist to facilitate organisations to provide appointment bookings for their customers or users. Typically, these involves access to electronic calendars and access to these via the internet via booking forms or the like.

However, an organization does not have any sophisticated control over how bookings are made and so improved technical tools are desirable.

### SUMMARY

According to a first aspect of the disclosure there is provided a computer-implemented method for allocating a resource or for scheduling an appointment, the method comprising
receiving a booking request from a user, and user information;
providing an index data structure comprising a plurality of parameters specific to an organization associated with the request; and
comparing the booking request with the index data structure to optimize at least one of a resource allocation and a scheduling of appointments.

For instance, a resource allocation may be an access to particular facility such as a sport center, a gym or a golf course. An appointment may refer to a particular service, such as a medical or a legal appointment.

For instance the index data structure may be a database such as a user behaviour database comprising a plurality of parameters. The user behaviour database may be generated by collecting user data information and behaviour over an extended period and updated over time. The parameters may be defined by the organization.

Optionally, the plurality of parameters comprises a plurality of user parameters. For instance a user parameter may comprise a cancelled booking parameter, a missed booking parameter, a group number parameter, a location parameter, a frequency of use parameter, a user category parameter, and other parameters relating to a behaviour or habit of the user.

Optionally, the method comprises calculating a user score for an identified user based on a plurality of selected user parameters and generating a schedule of availabilities for the identified user based on at least one of the user score and a predefined booking parameter.

Optionally, the predefined booking parameter comprises at least one of a fair-use coefficient and a profitability coefficient.

For instance the fair use coefficient may be configured to distribute access to the resource in an equitable fashion between users. The profitability coefficient may be configured to distribute access to the resource to maximise the use or profitability of the resource.

Optionally, the method comprises generating a waiting list and calculating a user ranking position on the waiting list based on at least one of the user score and the predefined booking parameter.

Optionally, the method comprises generating and sending a notification to a user device, wherein the notification comprises an option to accept an available time slot from a schedule of availabilities, within a predetermined timeframe.

Optionally, the predetermined timeframe is configurable based on the user score or on another predefined parameter.

Optionally, the method comprises sending the available time slot to another user device when the option to accept has been declined or when the timeframe has timed out.

Optionally, the schedule of availabilities comprises a plurality of time slots and the method comprising adjusting a plurality of gaps between the time slots to generate an additional time slot.

Optionally, calculating the user score comprises receiving configuration data comprising a set of selected parameters, a set of weights associated with each one of the selected parameters, and a set of coefficients associated with each one of the selected parameters; calculating a term for each selected parameter based on the weights and coefficients; and summing the terms to obtain the user score.

Optionally, the method comprises receiving geofenced positional data of a user when the user enters a geographic boundary; identifying the locations of the users within the geographic boundary; and predicting one or more available time slots based on the user locations within the geographic boundary.

According to a second aspect of the disclosure, there is provided a booking system comprising an interface configured to receive a booking request and user information; a memory configured to store an index data structure comprising a plurality of parameters specific to an organization associated with the request; and a processor configured to execute a matching engine, the matching engine being configured to compare the booking request with the index data structure to optimize at least one of a resource allocation and a scheduling of appointments.

Optionally, the plurality of parameters comprises a plurality of user parameters.

Optionally, the processor is configured to calculate a user score for an identified user based on a plurality of selected user parameters and generating a schedule of availabilities for the identified user based on at least one of the user score and a predefined booking parameter.

Optionally, the processor is configured to generate a waiting list and to calculate a user ranking position on the waiting list based on at least one of the user score and the predefined booking parameter.

Optionally, the processor is configured to generate a notification and send the notification to a user device via a communication interface, wherein the notification comprises an option to accept an available time slot from a schedule of availabilities, within a predetermined timeframe.

Optionally, the processor is configured to send the available time slot to another user device when the option to accept has been declined or when the timeframe has timed out.

Optionally, the processor is adapted to execute a score engine configured to receive configuration data comprising a set of selected parameters, a set of weights associated with each one of the selected parameters, and a set of coefficients associated with each one of the selected parameters; to calculate a term for each selected parameter based on the weights and coefficients; and to sum the terms to obtain the user score.

Optionally, the processor is configured to receive geofenced positional data of a user when the user enters a geographic boundary; to identify the locations of the users within the geographic boundary; and execute an algorithm to predicting one or more available time slots based on the user locations within the geographic boundary.

According to a third aspect of the disclosure, there is provided a computer-readable data carrier having stored thereon instructions which when executed by a computer cause the computer to carry out the method of the first aspect.

Additionally, geofenced positional data can be incorporated that can manage multiple participant locations and predict gaps or further availability. The system provides the ability to deal with a large number of concurrent calculations in near real time to and can send notifications at the speed required for dynamic bookings, which is beyond the capability of any manual system and furthermore not achievable with existing tools.

The index data structure and matching engine together cooperate to provide an optimized booking system where an organization can customize and control the customer experience and maximise their revenue while still providing equitable access to resource is for customers thus providing mutual benefit and sophisticated management of bookings which is not possible using available technologies.

The resource allocation and booking system is provided as a non-transitory computer program product which may be installed on one or more of an organisation's network, a consumer device or network, a service provider's network; or a suitable combination of these using suitable cloud technologies and with distribution of functionality between different organisations as desired.

### BRIEF DESCRIPTION OF THE DRAWINGS

The disclosure will be described in detail below, by way of example only, with reference to the accompanying drawings, in which:

FIG. 1 shows an example flow chart for an embodiment of the disclosure for managing bookings of a sports club, in particular in this example that of a golf club;

FIG. 2 shows some details of a physical implementation of the disclosure;

FIG. 3 is a diagram illustrating the generation of a customer score;

FIG. 4 shows another example flow chart for an embodiment of the disclosure for managing bookings.

### DETAILED DESCRIPTION

The present disclosure provides a system and method for resource allocation. This may, in particular, but not exclusively relate to a computer-implemented system for making and managing bookings and appointments. Bookings and appointments may be for any type of organization or facility but in order to give an example of how the disclosure may be implemented we will discuss the specific case of a golf club, where an administrator of the golf club facility wishes to manage bookings on behalf of members and/or non-members of the golf club.

A booking system according to the disclosure offers customers or other users a fair chance of getting a time slot, offering value for money of membership, reward loyalty, encourage participation. The organization/facility can also make smart decisions on allocation of slots balanced between customer experience and profitability for the facility.

The disclosure provides a booking system and waiting list, both of which provide preferential access to time-slots based on a customer category and an index of criteria with a percentage weighting to each criteria.

Customers get a fair opportunity at available time-slots/facilities based on their profile to enable participation, but the system also allows an administrator to set profitability/loyalty or VIP status. Once criteria have been set, the system then automates which users can see which range and waiting list offers made through app notifications, with a timer countdown which is also configurable.

The booking system has the ability to create more time-slots within a given time range by reducing the gap between slots. If an existing booking has been made, it will be maintained and the start time adjusted to the nearest time—for example, if slots changed from every 10 mins down to 8 mins, booking is maintained and start time adjusted from 9.10 am to 9.08 am, and a notification sent to all customers of the change.

For the bookings system, access to a range of available times can be defined by customer category; for example 5 days in advance for one category, 8 for another etc. It also uses an additional index separate to customer category, called here “The Index”, which can be defined by the system administrator; fair use, profitability, loyalty etc. which will also determine date range accessibility. The index is a data structure which is stored in a non-transitory computer readable memory, and which enables the allocation of bookings in a smart and intelligent manner to suit the organization's needs while at the same time ensuring a consistent customer experience. For instance the index data structure may be a user behaviour database comprising a plurality of parameters. The user behaviour database may be generated by collecting user data information and behaviour over an extended period and updated over time. The parameters may be defined by the organization.

For the waiting list, if customer's desired range is fully subscribed, customer can join waiting list, choose preferred date/time range and how many the request is for, which is used for decisions around profitability. Their position on the waiting list is then determined by The Index.

Newly available time-slots are offered to each client in order of their position on the waiting list.

Time-slot is then offered to user through notification sent via app to their device and they are given a timeframe to accept or decline, with the timeframe also customised by the administrator based on customer category. If the proposed time slot is declined or if the timeframe has timed-out, the user are assigned the attribute of “offered”. The time-slot will then be offered to next user on the waiting list and so on.

For events or competitions, customers can enter a ballot, which if oversubscribed can either be allocated at random or by applying The Index based on fair use, with any unsuccessful customers added to waiting list and made an offer upon slot becoming available, functionality the same as described above.

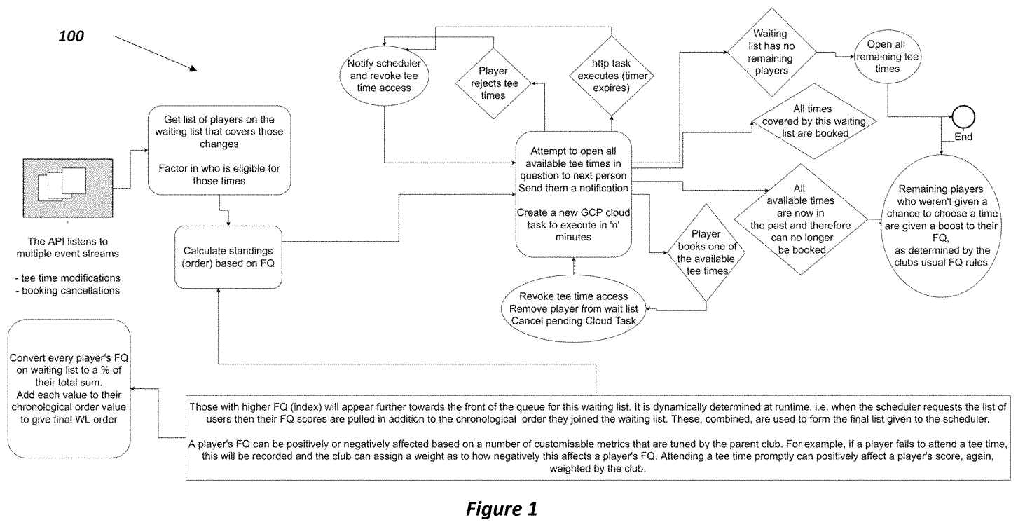

FIG. 1 illustrates aspects of the disclosure in more detail, for the example of a golf club. The text from the drawing may be incorporated into the present description, and a person skilled in the art will understand the logical flow of requests and responses that circulate between the components of the diagram. In the diagram, standings (order) can be calculated based on a customised parameter or user score, referred to here as fairtee quotient (FQ), but which could be labelled differently for different contexts.

The present disclosure may work with any suitable cloud service but in this example Google Cloud Platform (GCP) may be used. Every time a GCP cloud task is executed, it may be given a few parameters, such as:
The waiting list ID (in URL)
The time between triggers (how long each player has to book a time)
The current player ID who is being offered tee times
The previous state which can be:
   new—The first execution of a new waiting list
   accepted—When a player has booked a tee time
   rejected—When a player has explicitly rejected their tee time offers
   expired—When a player has not booked in time (triggered by the GCP cloud task that runs every time a new player is offered a time)

GCP cloud tasks are split into queues per club ID. They will call a particular endpoint on a service provider's API(s). They can hit any API which means there are no issues with scaling this process horizontally.

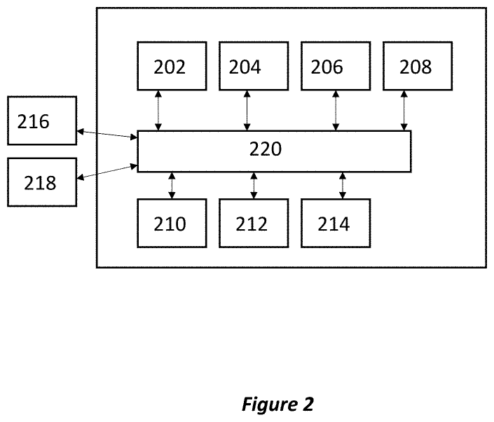

FIG. 2 is a schematic diagram of a computer system 200 which comprises specially modified components for implementing the system and carrying out the methods of this disclosure.

The computer system 200 comprises a module 202 which is configured as a resource allocation system configured to implement the methods of the present disclosure.

It is to be appreciated that various different architectures may be used. The overall system and method may be implemented by multiple computer systems 200 which may reside within the organization's network, at a customer device, in the cloud or an appropriate mixture of these components.

Furthermore, a service provider could run a cloud platform that provides intelligent booking systems for use by multiple organizations such that intelligent booking is a service can be provided for organizations' benefit.

The computer system 200 may comprise a processor 204, a storage device 206, RAM 208, ROM 210, a data interface 212, a communications interface 214, a display 216, and an input device 218. The computer system 200 may comprise a bus 220 to enable communication between the different components.

The computer system 200 may be configured to load an application. The instructions provided by the application may be carried out by the processor 204. The application may be a dedicated administrators' application for use by an organization, a consumer application for use by users who wish to make a booking or may be a web app that runs via a browser. The processor 204 may be adapted to execute a plurality of software engines including a matching engine configured to compare the booking request with the index data structure to optimize resource allocation and/or scheduling of appointments; and a score engine configured to calculate a user score and predictive algorithm for predicting available time slots. It will be appreciated that the processor may be implemented at least in part on a remote server.

A user may interact with the computer system 200 using the display 216 and the input device 218 to instruct the computer system 200 to implement the methods of the present disclosure in the allocation and booking of resources.

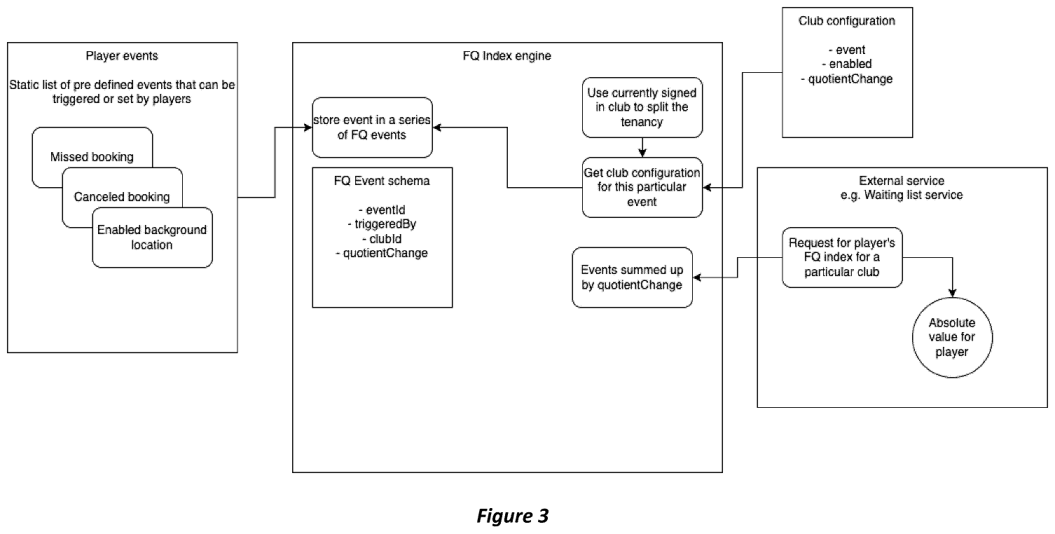

FIG. 3 is a diagram illustrating the generation of a user score. A software referred to as score engine, is configured to calculate a user score based on user behaviour past events. In this particular example the user score is calculated for users of a golf course and the score engine is referred to as FQ Index engine. The user score is computed as a sum of weighted parameters. The parameters may include a cancelled booking parameter, a missed booking parameter, a group number parameter, a location parameter, a frequency of use parameter and so on.

The score engine receives a series of user behaviour inputs, that may include for a specific user (having a specific ID) a number missed bookings, a number of cancelled bookings, a group size associated with the user (that is how many people a user may bring with him when booking a resource such as a golf course), details regarding availability of user location (that is whether the user enables or disables location data on his mobile phone), a frequency of use parameter, and the like. These user behaviour inputs are stored as a series of events to form a database of user behaviour. The user behaviour database is updated dynamically over time and can be questioned or analysed to retrieve user specific behaviour information.

The score engine receives configuration data to calculate the user score. The configuration data may include a set of selected parameters, a set of weights associated with each one of the selected parameters, and a set of coefficients associated with each one of the selected parameters. The configuration data are specific to a specific organisation. For instance a sport club will chose and provide different configuration data compared with a medical organisation.

For example, the score engine may have 10 parameters: P1-P10, and the configuration data may select parameter P3, P5 and P7 with a weight of 10% for P3, 50% for P5 and 40% for P7. The parameters P3, P5 and P7 may be attributed coefficients C3, C5 and C7. The coefficient may be a bonus or a malus, for example a positive number or a negative number depending on the user behaviour for that selected parameter. Alternatively, the coefficient may be implemented as a positive or negative percentage or a positive or negative factor.

The database is then used to retrieve and assign a value to each selected parameters based on the coefficient. For example let's assume that the parameter P3 is a cancelled booking parameter, and that the coefficient C3 attributes a positive value (for example +5) if no cancellation has occurred within the last 12 months and a negative value (for example −5) per cancellation over the last 12 months. The score engine can then interrogate the behaviour database for the relevant user and calculate a score term T3 for parameter P3. For example if the user has had no cancellation, then T3=10% of (+5)=0.5. Following this approach the score engine can then compute the user score X(user)=T3+T5+T7.

In the context of a request for booking a golf course, geofenced positional data may be used to identified opportunities for available slots dynamically, based on the locations of the users on the golf course. The location of the users on the golf course may be used to identify gaps on the course. As such a player may be able to start using the course at a specific point. For example if the course has 10 holes and most players are located before hole number 3 and after hole number 8. An available slot might be identified at hole number 5 at a particular time.

A geographic boundary, defined by GPS or RFID technology can be chosen around or within an area of the gold course. When a mobile device of a user enters or leaves a particular area around the golf course, a signal may be triggered that identify that a user is present on the course or has left the course. The locations of the users on the course are then monitored within the chosen boundary. Availabilities for available time slots at a particular location of the course can then be identified based on the user locations within the geographic boundary.

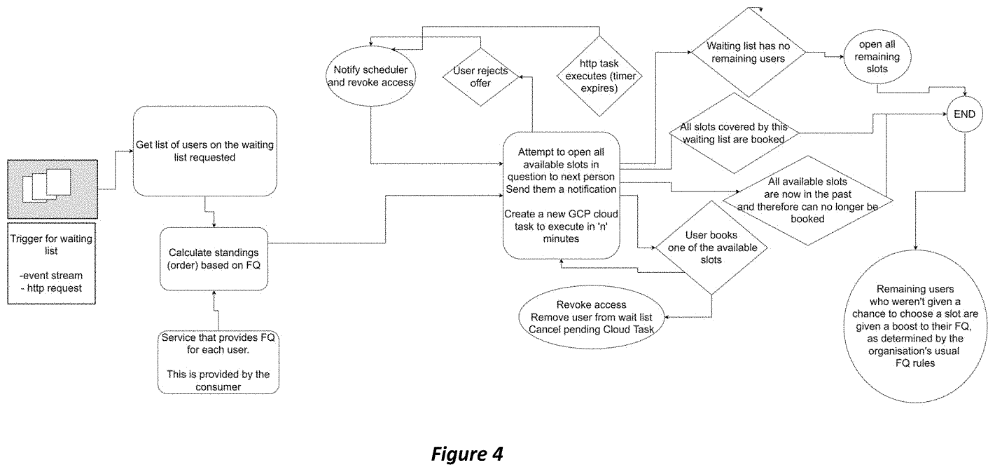

FIG. 4 shows another example flow chart for an embodiment of the disclosure for managing bookings. The text from the drawing may be incorporated into the present description, and a person skilled in the art will understand the logical flow of requests and responses that circulate between the components of the diagram.

Improvements and modifications can be made to the above without departing from the scope of the present disclosure. In particular, it is noted that the example of a golf club is not limiting, and indeed the disclosure may be applied to other sports facilities, other types of member organisations and generally to the allocation of resource where appointments need to be made. References have also been made to maximising profit, but the disclosure may be applied equally to profit making facilities and not-for-profit or free of charge facilities as well.

1. A computer-implemented method for allocating a resource or for scheduling an appointment, the method comprising
receiving a booking request from a user, and user information;
providing an index data structure comprising a plurality of parameters specific to an organization associated with the request; and
comparing the booking request with the index data structure to optimize at least one of a resource allocation and a scheduling of appointments.

2. The method as claimed in claim 1, wherein the plurality of parameters comprises a plurality of user parameters.

3. The method as claimed in claim 2, comprising calculating a user score for an identified user based on a plurality of selected user parameters and generating a schedule of availabilities for the identified user based on at least one of the user score and a predefined booking parameter.

4. The method as claimed in claim 3, wherein the predefined booking parameter comprises at least one of a fair-use coefficient and a profitability coefficient.

5. The method as claimed in claim 4, comprising generating a waiting list and calculating a user ranking position on the waiting list based on at least one of the user score and the predefined booking parameter.

6. The method as claimed in claim 3, comprising generating and sending a notification to a user device, wherein the notification comprises an option to accept an available time slot from a schedule of availabilities, within a predetermined timeframe.

7. The method as claimed in claim 6, wherein the predetermined timeframe is configurable based on the user score.

8. The method as claimed in claim 6, comprising sending the available time slot to another user device when the option to accept has been declined or when the timeframe has timed out.

9. The method as claimed in claim 6, wherein the schedule of availabilities comprises a plurality of time slots and the method comprising adjusting a plurality of gaps between the time slots to generate an additional time slot.

10. The method as claimed in claim 1, wherein calculating the user score comprises
receiving configuration data comprising a set of selected parameters, a set of weights associated with each one of the selected parameters, and a set of coefficients associated with each one of the selected parameters;
calculating a term for each selected parameter based on the weights and coefficients; and
summing the terms to obtain the user score.

11. The method as claimed in claim 1, comprising
receiving geofenced positional data of a user when the user enters a geographic boundary;
identifying the locations of the users within the geographic boundary; and
predicting one or more available time slots based on the user locations within the geographic boundary.

12. A booking system comprising
an interface configured to receive a booking request and user information;
a memory configured to store an index data structure comprising a plurality of parameters specific to an organization associated with the request; and
a processor configured to execute a matching engine, the matching engine being configured to compare the booking request with the index data structure to optimize at least one of a resource allocation and a scheduling of appointments.

13. The booking system as claimed in claim 12, wherein the plurality of parameters comprises a plurality of user parameters.

14. The booking system as claimed in claim 12, wherein the processor is configured to calculate a user score for an identified user based on a plurality of selected user parameters and generating a schedule of availabilities for the identified user based on at least one of the user score and a predefined booking parameter.

15. The booking system as claimed in claim 12, wherein the processor is configured to generate a waiting list and to calculate a user ranking position on the waiting list based on at least one of the user score and the predefined booking parameter.

16. The booking system as claimed in claim 12, wherein the processor is configured to generate a notification and send the notification to a user device via a communication interface, wherein the notification comprises an option to accept an available time slot from a schedule of availabilities, within a predetermined timeframe.

17. The booking system as claimed in claim 15, wherein the processor is configured to send the available time slot to another user device when the option to accept has been declined or when the timeframe has timed out.

18. The booking system as claimed in claim 12, wherein the processor is adapted to execute a score engine configured to receive configuration data comprising a set of selected parameters, a set of weights associated with each one of the selected parameters, and a set of coefficients associated with each one of the selected parameters; to calculate a term for each selected parameter based on the weights and coefficients; and to sum the terms to obtain the user score.

19. The booking system as claimed in claim 12, wherein the processor is configured to receive geofenced positional data of a user when the user enters a geographic boundary; to identify the locations of the users within the geographic boundary; and execute an algorithm to predicting one or more available time slots based on the user locations within the geographic boundary.

20. A computer-readable data carrier having stored thereon instructions which when executed by a computer cause the computer to carry out the method of claim 1.
